(19) United States
(12) Patent Application Publication
(10) Pub. No.: US 2026/0202713 A1
(43) Pub. Date: Jul. 16, 2026

(54) Detecting Electromagnetic Radiation with Improved Signal-to-Noise

(71) Applicant: Andres Zuluaga, Chestnut Hill, MA (US)

(72) Inventor: Andres Zuluaga, Chestnut Hill, MA (US)

(21) Appl. No.: 19/136,410

(22) PCT Filed: Dec. 5, 2023
(86) PCT No.: PCT/US2023/082490

§ 371 Date: Jun. 6, 2025

Related U.S. Application Data
(60) Provisional application No. 63/430,468, filed on Dec. 6, 2022.

(51) Int. Cl. G02F 1/39; G02B 1/00; G02F 1/00

(52) U.S. Cl. CPC G02F 1/397; G02B 1/002; G02F 1/0018; G02F 1/0036; G02F 2202/13

(57) ABSTRACT

An optical-detection apparatus that includes an interference mixer that comprises a medium upon which are incident a sample beam and a pump beam that propagate in different directions through said medium. The mixer outputs an amplified sample beam as a result of having caused energy transfer from the pump beam to the sample beam.

### CROSS REFERENCE TO RELATED APPLICATIONS

This application claims priority to U.S. Application No. 63/430,468, filed Dec. 6, 2022, the contents of which is hereby incorporated by reference in its entirety.

### FIELD OF INVENTION

The invention relates to enhancement of signal-to-noise ratio and in particular to the use of a pump beam to enhance signal-to-noise ratio in a sample beam.

### BACKGROUND

It is possible to detect various phenomena by allowing a beam of electromagnetic radiation to interact with a structure and observing the manner in which the structure modulates the properties of the wave. Such a wave, with its properties having been altered, will be referred to herein as a “sample beam.”

In many cases, the effect is small and easily overlooked. In particular, it is often the case that the effect is overwhelmed or buried by noise. It is therefore useful to amplify the sample beam in some way so that the modulation that it carries can be more easily detected. One way to do so is to allow the sample beam to mix with a coherent pump beam. This method is used in a synchronous, homodyne or heterodyne, coherent detection system.

This can be carried out by allowing the sample beam and pump beam to pass through the same volume of space. The resulting sample beam will then attain a signal level that is proportional to the square root of the product of the intensities of the two beams. The result is then provided to a detector, such as a photodiode or CCD.

A difficulty that arises is shot noise in the detector. This shot noise arises as a result of the sum of the intensities of the two beams in addition to the signal level.

### SUMMARY

The invention introduces an interference mixer into a detection system that coherently mixes signal and pump beams by allowing them to spatially overlap within the interference mixer. The signal beam, after having been amplified using energy in the pump beam, emerges from one port of the interference mixer. The pump beam, after having given up some of its energy to the sample beam, emerges from a different port. The interference mixer thus receives spatially separate beams, allows them to overlap briefly, and then separates them again.

The interference mixer reacts to interference between the two beams as they traverse the interference mixer in different directions. In particular, the interference mixer reacts by changing its properties. This interference leads to power transfer from the pump beam to the sample beam. In some embodiments, it does so without the need to alter the beams'paths through the interference mixer. The resulting power transfer maintains a background noise level that is proportional to that in the now amplified sample beam.

Examples of suitable optical media include photorefractive materials.

Additional examples include engineered optical materials, such as those having engineered metasurfaces. Also suitable as optical media are engineered hybrid materials that comprise both organic and inorganic photorefractive elements.

Embodiments in which the interference mixer is a metamaterial include those in which the interference mixer comprises a substrate upon which certain features have been formed.

These features are of a size that is less than wavelengths of the radiation that comprises the two beams.

Other embodiments include those in which single source is followed by a splitter, which forms the sample beam and the pump beam. This is particularly useful for providing spatially separate and coherent beams.

Embodiments include those in which the features are resonant when only a first beam of the two beams is present and that fall from resonance when both beams are present.

Embodiments include those in which the first beam is the pump beam and those in which the first beam is the sample beam.

Alternatively, there also exist embodiments in which the features resonate in the presence of both beams and lose resonance upon removal of one of the two beams.

As used herein, “resonance” refers to a marked change in the nature of the interaction of the radiation with the features, the interaction including one or both of scattering and absorption. This occurs, for example, when the radiation comprises a frequency component that is close to or at a natural frequency defined by the features.

In some embodiments, the interference mixer comprises a metamaterial or a metasurface thereof is engineered to allow interaction with a beam without changing the beam's direction of propagation.

In other embodiments, the interference mixer comprises a metamaterial or a metasurface thereof is engineered to alter a beam's direction of propagation during a resonance condition.

In other embodiments, the interference mixer comprises a metamaterial or a metasurface thereof is engineered such that radiation that interacts with some features in a first subset of features does not interact significantly with features in a second subset of the features.

In still other embodiments, the interference mixer comprises a metamaterial or a metasurface thereof is engineered such that induced radiation, which arises from interaction of incident radiation with features in a first subset of the features does not interact with features in a second subset of the features.

In still other embodiments, the interference mixer comprises a metamaterial or a metasurface thereof is engineered such that radiation at a feature from a first subset of features or radiation induced as a result of radiation interacting with that feature interacts significantly with features in a second subset of features.

Among the embodiments are those in which the various features are disposed in a spatially varying field resulting from the superposition of two beams having Poynting vectors with a non-zero inner product so as to sample the spatial periodicity of the resulting superposition.

In one aspect, the invention features an apparatus for optical detection. Such an apparatus includes a mixer that includes a medium upon which are incident a sample beam and a pump beam, the sample beam and the pump beam being oriented to propagate in different directions through the medium. The mixer outputs an amplified sample beam. Amplification arises because the medium causes energy transfer from the pump beam to the sample beam.

Embodiments include those that further comprise a first source for providing the sample beam, a second source for providing the pump beam, and a detector configured to receive the output of the mixer.

In some embodiments, the medium includes a photoreactive material. In others, it includes a metamaterial comprising features that interact with at least one of the beams. In still others, the medium includes a material having a metasurface having features that interact with at least one of the beams.

Still other embodiments include those in which the medium changes its index of refraction in response to an applied electromagnetic field and those in which it changes its index of reaction in response to an applied mechanical field.

Also among the embodiments are those in which the medium comprises liquid crystal and those in which it comprises a piezoelectric material.

Still other embodiments of the medium are those that comprise a surface that comprises a two-dimensional arrangement of sub-wavelength features, those that comprise a three-dimensional arrangement of sub-wavelength features.

In some embodiments, the medium includes at least one layer of structures that are disposed periodically in the medium. In others, the medium includes at least one layer of structures that are disposed quasi-periodically in the medium. In yet other embodiments, the medium includes at least one layer of structures that are separated by a value formed by a fixed value and a random variable having a probability distribution with zero mean.

Also among the embodiments are those in which medium includes structures that are disposed to interact with at least one of the beams to form a diffraction pattern within the medium, those in which the structures are disposed to interact with at least one of the beams to form a diffraction pattern in the near field adjacent to the medium, and those in which the structures are disposed to interact with at least one of the beams to form a diffraction pattern in the far-field surrounding the medium.

### BRIEF DESCRIPTION OF THE FIGURES

FIG. 1 shows a beam coupler.

### DETAILED DESCRIPTION

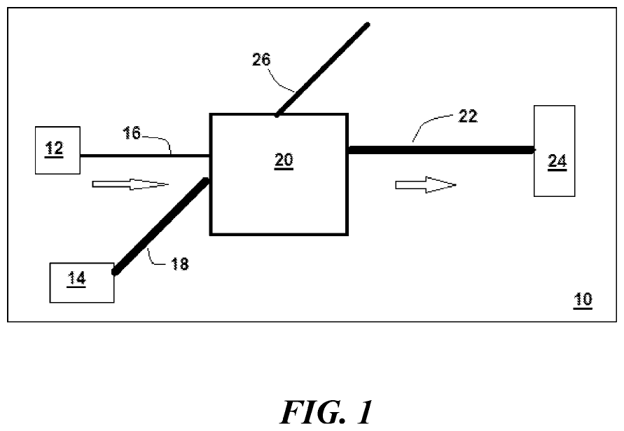

FIG. 1 shows a detection system 10 having first and second beam sources 12, 14. The first beam source 12 provides a sample beam 16 and the second beam source 14 provides a pump beam 18. The pump beam 18 has higher power than the sample beam 16.

The sample beam 16 and the pump beam 18 propagate along first and second directions towards an interference mixer 20. The interference mixer 20 comprises a volume in which the sample beam 16 and pump beam 18 interfere with each other. As a result of this interference, power from the pump beam 18 is coupled into the sample beam 16. This results in an augmented sample beam 22 that propagates along a third rection to a detector 24. Meanwhile, a diminished pump beam 26 exits the interference mixer 20 along a fourth direction.

In some embodiments, the interference mixer 20 comprises a photorefractive material. In other embodiments, the interference mixer 20 comprises a combination of photorefractive material and liquid crystal. In still other embodiments, the interference mixer 20 comprises a photoreactive material that is coupled to one or more other materials that change optical properties, such as index of refraction or magnetic permittivity, in response to the presence of the two beams.

In other embodiments, the interference mixer 20 comprises an engineered metamaterial having features disposed in a spatially periodic distribution through the bulk material that comprises the interference mixer 20, on the surface of the interference mixer 20, or a combination thereof.

1. An apparatus for optical detection, said apparatus comprising a mixer that comprises a medium upon which are incident a sample beam and a pump beam, said sample beam and said pump beam being oriented to propagate in different directions through said medium, said mixer having an output that outputs an amplified sample beam, wherein said medium causes energy transfer from said pump beam to said sample beam.

2. The apparatus of claim 1, wherein said medium comprises a photoreactive material.

3. The apparatus of claim 1, wherein said medium comprises a metamaterial comprising features that interact with at least one of said beams.

4. The apparatus of claim 1, wherein said medium comprises a material having a metasurface having features that interact with at least one of said beams.

5. The apparatus of claim 1, wherein said medium comprises at least one layer of structures that are disposed periodically in said medium.

6. The apparatus of claim 1, wherein said medium comprises at least one layer of structures that are disposed quasi-periodically in said medium.

7. The apparatus of claim 1, wherein said medium comprises at least one layer of structures that are separated by a value formed by a fixed value and a random variable having a probability distribution with zero mean.

8. The apparatus of claim 1, wherein said medium comprises structures that are disposed to interact with at least one of said beams to form a diffraction pattern within said medium.

9. The apparatus of claim 1, further comprising a first source for providing said sample beam, a second source for providing said pump beam, and a detector configured to receive said output of said mixer.

10. The apparatus of claim 1, wherein said medium comprises an assembly of photorefractive materials and at least one of an electro-reactive material and a magneto-reactive material.

11. The apparatus of claim 1, wherein said medium comprises an assembly of metamaterials and at least one of an electro-reactive material and a magneto-reactive material.

12. The apparatus of claim 1, wherein said medium comprises an assembly of metasurfaces and at least one of an electro-reactive material and a magneto-reactive material.
